(19) United States
(12) Patent Application Publication
(10) Pub. No.: US 2024/0408770 A1
(43) Pub. Date: Dec. 12, 2024

(54) ROBOTIC PNEUMATIC GRIPPER, GRIPPING METHOD AND PNEUMATIC CIRCUIT

(71) Applicant: EXOTEC PRODUCT FRANCE, CROIX (FR)

(72) Inventors: Bastien CAGNAC, Wasquehal (FR); Julien MOURET, MARCQ EN BAROEUL (FR); Benjamin SIX, LILLE (FR)

(73) Assignee: EXOTEC PRODUCT FRANCE, CROIX (FR)

(21) Appl. No.: 18/737,051

(22) Filed: Jun. 7, 2024

(30) Foreign Application Priority Data
Jun. 8, 2023 (FR) 2305810

(51) Int. Cl. B25J 15/06

(52) U.S. Cl. CPC B25J 15/0658; B25J 15/0633

(57) ABSTRACT

A robotic pneumatic gripper including a robotic arm; an effector including at least one gripping member such as a suction cup or foam; and a pneumatic circuit for controlled negative pressure at the at least one gripping member, the pneumatic circuit including a vacuum source; a main pipe connecting the vacuum source to the gripping member; and an auxiliary pipe connected to the main pipe at one or more nodes, the auxiliary pipe being provided with a valve configured to switch between a closed position where the auxiliary pipe is closed off, and an open position where the node is fluidly connected to the atmosphere.

### FIELD

The present disclosure relates to the field of logistics, particularly in automated warehouses, and more particularly to “picking” operations, a term which designates the action of grasping an item in order to extract it from a group of items present in a container and place it in another specific container, for example for the preparation of commercial orders.

### BACKGROUND

It is known to have such gripping operations carried out by robotic devices, in particular by programmable arms, generally movable along 5 or 6 axes, and provided at their mobile end with an effector equipped with a gripping member comprising for example a suction cup and/or a foam, which allows carrying out the object-gripping operation.

The objects may be of different sizes, shapes, and weights, and may even have different surface textures.

For the gripping member to be able to grip the object, a pneumatic circuit is generally provided which may include a vacuum source, such as a pump, configured to create, at the gripping member, a negative pressure necessary for grasping the object. For example, document EP2150382B1 describes a pneumatic circuit for a robotic pneumatic gripper comprising a source of compressed air which supplies a Venturi vacuum generator via a supply pipe, the Venturi in turn connected to a suction cup via a suction pipe. A first valve controls the air supply to the Venturi and a pressure-limiting second valve brings the suction cup to atmospheric pressure when the compressed air supply is turned off. Thus, during the gripping phase, the compressed air source is turned on, creating negative pressure in the suction line, via the Venturi, which allows the suction cup to grip an object. During the release phase, the compressed air source is stopped, and the pressure-limiting second valve opens in order to return the suction cup to atmospheric pressure and release the object. A similar pneumatic circuit is described in document EP2104640 B1.

In such a system, with each object placement operation it is necessary to turn off the pump to cancel the suction effect. Such a process is not desirable because successively restarting the vacuum source can deteriorate it prematurely. It is generally recommended not to exceed ten start-ups per hour. However, the rates that need to be maintained for an industrial “picking” application are more on the order of 600 picking operations (grasping and release cycle) per hour. A simple suction system is therefore not suitable for gripping applications in an automated warehouse.

It was therefore necessary to develop a means which allows grasping and releasing an object while keeping the vacuum source continuously working.

A means such as a valve allows opening the pneumatic circuit between the vacuum source and the gripping member, and thus intermittently connecting the gripping member to the atmosphere in order to release the gripped objects.

Patent document WO 2019/094382-A1 discloses in particular the use of a 3-way and 2-position valve to alternately allow grasping and setting down objects at rates suitable for industrial use, while keeping the vacuum source continuously working.

However, integrating such a valve into the circuit remains complex and its use can induce pressure losses which degrade the performance of the device.

### SUMMARY

The present disclosure improves the situation by proposing a system that is simple in concept, which guarantees a long lifespan for the vacuum source and which reduces pressure losses compared to the concept described above.

A robotic pneumatic gripper is proposed, comprising:
a robotic arm;
an effector arranged at a movable end of the robotic arm, the effector comprising at least one gripping member such as a suction cup or foam; and
a pneumatic circuit for controlling negative pressure at the at least one gripping member, the pneumatic circuit comprising:
   a vacuum source;
   a main pipe connecting the vacuum source to the gripping member; and
   an auxiliary pipe connected to the main pipe at one or more nodes, the auxiliary pipe being provided with a valve configured to switch between a closed position where the auxiliary pipe is closed off, and an open position where the node is fluidly connected to the atmosphere.

The features set forth in the following paragraphs may optionally be implemented, independently of each other or in combination with each other:

According to one improvement, the valve is a 2-way, 2-position valve.

According to one improvement, there is only one node.

According to one improvement, all or part of the pneumatic circuit is integrated into the robotic arm, and is therefore movable with it.

According to one improvement, the vacuum source is a Venturi effect source.

According to one improvement, the vacuum source is a rotary vane vacuum pump.

According to one improvement, the vacuum source is a turbine pump.

According to one improvement, the valve comprises a mouth that is open to the atmosphere and a filtration device at said mouth.

The present disclosure further relates to a method comprising the following steps:
activating the vacuum source;
approaching the at least one gripping member to an object to be manipulated;
grasping the object by establishing a negative pressure in the gripping member, obtained either by activating the vacuum source if the valve is normally closed, or by switching the valve to the closed position;
moving the object via the motorized arm to a desired location,
setting down the object by restoring the gripping member to atmospheric pressure, obtained by switching the valve to the open position.

The present disclosure also relates to a pneumatic circuit for controlling negative pressure in a gripping member, the circuit comprising:
a vacuum source;
a main pipe intended to connect the vacuum source to the gripping member; and
an auxiliary pipe connected to the main pipe at one or more nodes, the auxiliary pipe being provided with a valve configured to switch between a closed position where the auxiliary pipe is closed off, and an open position where the node is fluidly connected to the atmosphere.

### BRIEF DESCRIPTION OF DRAWINGS

Other features, details and advantages will become apparent upon reading the detailed description below, and upon analyzing the attached drawings, in which:

FIG. 1 shows a robotic pneumatic gripper according to one embodiment.

FIG. 2 shows a diagram of a prior art pneumatic circuit.

FIG. 3 shows a diagram of the pneumatic circuit according to one embodiment of the present disclosure.

### DETAILED DESCRIPTION

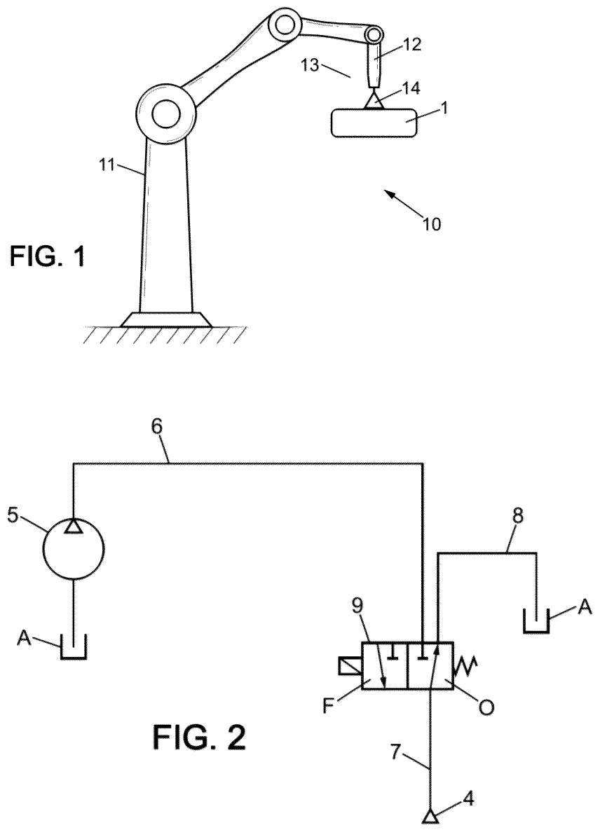

FIG. 1 shows a robotic pneumatic gripper 10 according to the present disclosure. Gripper 10 is shown during an operation of gripping an object 1.

Gripper 10 may include a robotic arm 11, for example a programmable robotic arm that is movable in 360 degrees along several axes, in particular along 5 or 6 axes. Other robotic structures are also possible, such as a gantry structure.

Gripper 10 may include a processor (not shown) capable of executing a program which contains instructions for controlling the gripper. It may also comprise a human-machine interface for controlling it manually.

The gripper may in particular be equipped with an optical sensor (not shown), for example a camera, to collect information about the object to be grasped, in particular its position, shape, size, etc.

Robotic arm 11 may include a free end 13, opposite to an end fixed to the ground or to any structure. At free end 13 is arranged an effector 12, which is provided with at least one gripping member 4, 14. It may be advantageous to provide effector 12 with several gripping members, in particular for gripping an object of more complex shape, or larger, or heavier.

Gripper 10 may include a pneumatic circuit, configured for the circulation of a gaseous fluid, for example air, and for enabling the creation of a suction force at gripping member 4, 14.

A pneumatic circuit of the prior art will now be described with reference to FIG. 2.

Such a known circuit comprises a first pipe 6, which allows fluidly connecting a vacuum source 5 to gripping member 4 via a valve 9. The valve is generally of the “3/2” type, i.e. it distributes the fluid between three paths, typically an inlet, an outlet, and a vent, and can switch between two positions: a closed position F and an open position O (shown in FIG. 2).

The circuit further comprises a second pipe 7 which fluidly connects the outlet of valve 9 to gripping member 4, and comprises a third pipe 8 which fluidly connects valve 9 to atmospheric pressure. Generally speaking, it may comprise a pipe that is open to the atmosphere A.

Thus, the closed position F of valve 9 allows connecting first pipe 6 to second pipe 7, and thus fluidly connect vacuum source 5 to gripping member 4 in order to create negative pressure in the gripping member and thus create the suction force required to grasp an object.

Conversely, the open position O allows closing off first pipe 6, and allows connecting second pipe 7 to third pipe 8, and thus connecting gripping member 4 to the atmosphere A. This has the effect of restoring gripping member 4 to atmospheric pressure and stopping the suction force, so as to release the object.

This known embodiment of a pneumatic circuit makes it possible to avoid frequent restarts of the vacuum source, which can therefore always remain active. However, the “3/2” valve and the three separate lines remain complex to integrate into the gripper system.

In addition, this type of circuit may introduce a large number of restrictions, due in particular to the internal geometric complexity of the “3/2” valve, which imply a vacuum loss of up to 20% at the gripping member, relative to the level of vacuum at the outlet of vacuum source 5. This degrades the performance of the system, particularly in operations that grip objects having a porous surface or a high mass.

Furthermore, in such a known circuit, when the valve is in the closed position F, the vacuum source continues to “suck” against the inlet of the valve which is closed off. This is not desirable in optimizing the lifespan of vacuum source 5 and valve 9, which may see premature deterioration of their internal components. This may also have the effect of unnecessarily increasing the energy consumption of the vacuum source.

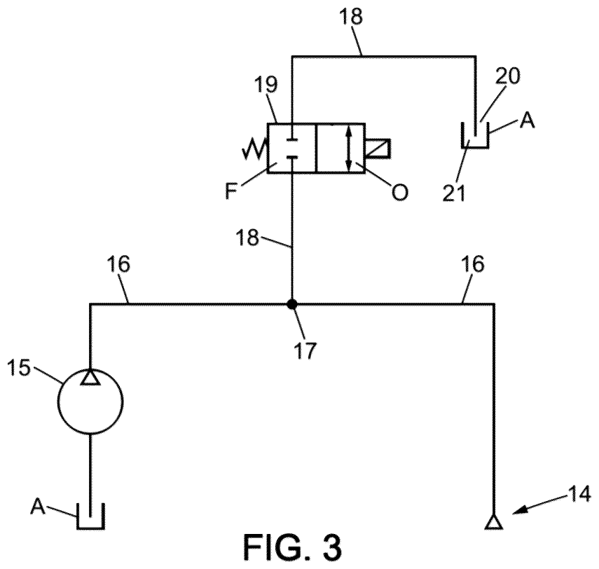

One embodiment of the present disclosure will now be described with reference to FIG. 3.

The pneumatic circuit of pneumatic gripper 10, according to one embodiment of the present disclosure, may comprise a main pipe 16 connecting vacuum source 15 to gripping member 14, and an auxiliary pipe 18 connected to the pipe main at at least one node 17.

Vacuum source 15 may be of the Venturi effect type or may consist of a rotary vane pump or a turbine vacuum pump. Alternatively, several vacuum sources of the same type or of different types may be combined.

The at least one node 17 allows fluid connection of the auxiliary pipe to the main pipe at an intermediate point between vacuum source 15 and gripping member 14. A node within the meaning of the present disclosure is therefore a connection having at least three openings, making it possible to connect at least two pipes.

Auxiliary pipe 18 may be provided with a valve 19 which may be configured to alternately close off and open up the circuit to the atmosphere. When valve 19 is closed, the negative pressure created by the vacuum source reaches gripping member 14: it is then possible to grasp an object. When valve 19 is open, node 17 is open to the atmosphere and vacuum source 15, still in operation, no longer creates a negative pressure in main pipe 16: the gripped object is released.

In a preferred embodiment, the circuit has a single node. The fluid can then circulate freely in three branches, composed of the two main pipes and the auxiliary pipe, which meet at node 17, as shown in FIG. 3.

In a preferred embodiment, the valve is of the “2/2” type, and allows connecting two channels, an input channel and an output channel, and can switch between two positions: a closed position F and an open position O. Thus, the circuit greatly gains simplicity in its implementation, which provides an economic gain as well as the beneficial effect of limiting pressure losses in the valve, the valve being less complex and presenting fewer restrictions than the “3/2” valves of the prior art.

With this configuration, the closed position F of valve 19 allows closing off the connection of the auxiliary pipe to the atmosphere A, and thus allows fluidly connecting vacuum source 15 to gripping member 14 to create a negative pressure in the gripping member and thus create the suction force necessary to grasp an object.

Conversely, the open position O allows connecting main pipe 16 to auxiliary pipe 18, and thus allows connecting gripping member 14 and vacuum source 15 to the atmosphere A. This has the effect of returning gripping member 14 to atmospheric pressure and stopping the suction force, so as to release the object.

When valve 19 is in the open position O, vacuum source 15 is therefore also connected to the atmosphere A by a mouth 20 of the valve or of the auxiliary pipe. The system being configured so that vacuum source 15 remains working, this results in uninterrupted suction at the mouth by vacuum source 15. Pneumatic gripper 10 may therefore comprise, at mouth 20 of valve 19, a filtration device 21, for example such as a mesh, to prevent suctioning in material which could damage the internal components of the circuit, in particular valve 19 and/or vacuum source 15.

All or part of the pneumatic circuit may be integrated into the robotic arm, and therefore may be movable with it.

The present disclosure also relates to a method for gripping objects, implemented by a pneumatic gripper 10 as described above, the method comprising the following steps:
activating vacuum source 15;
approaching the at least one gripping member to an object 1 to be manipulated;
grasping object 1 by establishing a negative pressure in gripping member 14, obtained either by activating the vacuum source if the valve is normally closed, or by switching the valve 19 to the closed position if it is normally open;
moving object 1 via motorized arm 11 to a desired location; and
setting down object 1 by restoring gripping member 14 to atmospheric pressure, obtained by switching valve 19 to the open position O.

The first activation step is only necessary if the vacuum source has been deactivated for any reason, for example at the end of the previous gripping cycle, or for example during an emergency stop, or if this is the first gripping cycle. Generally speaking, vacuum source 15 is constantly on.

Valve 19 may be normally open or normally closed. In a preferred embodiment, it is normally closed, which implies that valve 19 is only controlled to switch to the open position and to set down object 1. But it is also possible to provide for the valve normally being open: then the valve will be controlled to grasp the object. Alternatively, the valve may be double-acting and therefore have no preferred default position.

### INDUSTRIAL APPLICATION

These technical solutions may be applied in particular in the field of automated warehouse logistics, and more particularly during “picking” operations, for example for the preparation of commercial orders.

### LIST OF REFERENCE SYMBOLS

1. Object
4, 14: gripping member
5, 15: vacuum source
6: first pipe
7: second pipe
8: third pipe
9, 19: valve
10: robotic pneumatic gripper
11: robotic arm
12: effector
13: free end
14: gripping member
15: vacuum source
16: main pipe
17: node
18: auxiliary pipe
19: valve
20: mouth
21: filtration device
A: atmosphere
F: closed position
O: open position

1. A robotic pneumatic gripper comprising:
a robotic arm;
an effector arranged at a movable end of the robotic arm, the effector comprising at least one gripping member; and
a pneumatic circuit for controlling negative pressure at the at least one gripping member, the pneumatic circuit comprising:
a vacuum source configured to provide uninterrupted suction;
a main pipe connecting the vacuum source to the gripping member; and
an auxiliary pipe connected to the main pipe at one or more nodes, the auxiliary pipe being provided with a valve configured to switch between a closed position where the auxiliary pipe is closed off, and an open position where the node is fluidly connected to the atmosphere, the closed position of the valve making it possible to close off the connection of the auxiliary pipe to the atmosphere, and thus fluidly connect the vacuum source to the gripping member in order to create negative pressure in the gripping member and thus create a suction force required to grasp an object.

2. The robotic pneumatic gripper according to claim 1, wherein the valve is a 2-way, 2-position valve.

3. The robotic pneumatic gripper according to claim 1, wherein the one or more nodes comprise exactly one node.

4. The robotic pneumatic gripper according to claim 1, wherein all or part of the pneumatic circuit is integrated into the robotic arm, and is therefore movable with the robotic arm.

5. The robotic pneumatic gripper according to claim 1, wherein the vacuum source is a Venturi effect source.

6. The robotic pneumatic gripper according to claim 1, wherein the vacuum source is a rotary vane vacuum pump.

7. The robotic pneumatic gripper according to claim 1, wherein the vacuum source is a turbine pump.

8. The robotic pneumatic gripper according to claim 1, wherein the valve comprises a mouth that is open to the atmosphere and wherein a filtration device is arranged at said mouth.

9. The robotic pneumatic gripper according to claim 1, wherein the gripping member comprises at least one of: a suction cup; and foam.

10. A method for gripping an object, implemented by a robotic pneumatic gripper, the robotic pneumatic gripper comprising a robotic arm; an effector arranged at a movable end of the robotic arm, the effector comprising at least one gripping member; and a pneumatic circuit for controlling negative pressure at the at least one gripping member, the pneumatic circuit comprising: a vacuum source configured to provide uninterrupted suction; a main pipe connecting the vacuum source to the gripping member; and an auxiliary pipe connected to the main pipe at one or more nodes, the auxiliary pipe being provided with a valve configured to switch between a closed position where the auxiliary pipe is closed off, and an open position where the node is fluidly connected to the atmosphere, the closed position of the valve making it possible to close off the connection of the auxiliary pipe to the atmosphere, and thus fluidly connect the vacuum source to the gripping member in order to create negative pressure in the gripping member and thus create a suction force required to grasp an object, the method comprising the following steps:
activating the vacuum source;
approaching the at least one gripping member to the object;
grasping the object by establishing a negative pressure in the gripping member, by switching the valve to the closed position;
moving the object via the motorized arm to a desired location;
setting down the object by restoring the gripping member to atmospheric pressure, obtained by switching the valve to the open position, while the vacuum source is kept active.

11. A pneumatic circuit for controlling negative pressure in a gripping member, the pneumatic circuit comprising:
a vacuum source configured to provide uninterrupted suction;
a main pipe intended to connect the vacuum source to the gripping member; and
an auxiliary pipe connected to the main pipe at one or more nodes,
the auxiliary pipe being provided with a valve configured to switch between a closed position where the auxiliary pipe is closed off, and an open position where the node is fluidly connected to the atmosphere, the closed position of the valve making it possible to close off the connection of the auxiliary pipe to the atmosphere, and thus fluidly connect the vacuum source to the gripping member in order to create negative pressure in the gripping member and thus create a suction force required to grasp an object.

12. The pneumatic circuit according to claim 11, wherein the valve is a 2-way, 2-position valve.

13. The pneumatic circuit according to claim 11, wherein the one or more nodes comprise exactly one node.

14. The pneumatic circuit according to claim 11, wherein the vacuum source is a Venturi effect source.

15. The pneumatic circuit according to claim 11, wherein the vacuum source is a rotary vane vacuum pump.

16. The pneumatic circuit according to claim 11, wherein the vacuum source is a turbine pump.

17. The pneumatic circuit according to claim 11, wherein the valve comprises a mouth that is open to the atmosphere and wherein a filtration device is arranged at said mouth.
